(19) United States
(12) Patent Application Publication
(10) Pub. No.: US 2013/0054299 A1
(43) Pub. Date: Feb. 28, 2013

(54) USER INTERFACE FOR DYNAMIC WORKFLOW STATE MANAGEMENT

(71) Applicants: DEEPAK ARUN DESHPANDE, Pune (IN); Anindya Neogi, New Delhi (IN); Priti P. Patil, Pune (IN)

(72) Inventors: DEEPAK ARUN DESHPANDE, Pune (IN); Anindya Neogi, New Delhi (IN); Priti P. Patil, Pune (IN)

(73) Assignee: International Business Machines Corporation, Armonk, NY (US)

(21) Appl. No.: 13/214,332

(22) Filed: Aug. 22, 2011

(51) Int. Cl. G06Q 10/00

(52) U.S. Cl. 705/7.26

(57) ABSTRACT

A method, system, and computer program product for user interface for dynamic workflow state management are provided in the illustrative embodiments. A set of steps of a workflow is presented as a set of tabs in a graphical user interface (UI). Each tab includes a visual indicator indicating a status of a corresponding step associated with that tab. Tor a step in the set of steps, a visual indicator in a tab is used to depict a status of the step in the workflow, the visual indicator visually changing with a change in the status of the step. A status update is received for the step. A determination is made whether the status update also includes a status update for a related step in the workflow, A visual indicator corresponding to the related step is changed in accordance with the status update for the related step.

### TECHNICAL FIELD

The present invention relates generally to a computer implemented method, system, and computer program product for managing a workflow. Particularly, the present invention relates to a computer implemented method, system, and computer program product for user interface for dynamic workflow state management.

### BACKGROUND

A workflow is an ordered arrangement of steps required to complete a given task. For example, a process may be completed if steps 1, 2, and 3 of the process are completed sequentially, parallel, or in a particular order.

Depending on the complexity of the task being accomplished, a corresponding workflow can include any number of steps. Furthermore, a step in a workflow can have a number of sub-steps, such that for completing the step, the sub-steps have to be performed in some order. For certain tasks, the workflow can be quite complex and elaborate.

For such tasks, typically a team of users, a set of systems, or a combination thereof, perform certain steps or sub-steps. Managing the progress of a task using a workflow is therefore a non-trivial problem.

### SUMMARY

The illustrative embodiments provide a method, system, and computer program product for user interface for dynamic workflow state management. An embodiment presents a set of steps of a workflow as a set of tabs in a graphical user interface (UI) displayed using an application executing in a first data processing system, each tab in the set of tabs including a visual indicator configured to indicate a current status of a corresponding step in the set of steps associated with that tab. The embodiment depicts, for a step in the set of steps, using a visual indicator in a tab in the set of tabs, in the graphical UI, a current status of the step in the workflow, the visual indicator being configured to visually change with a change in the status of the step. The embodiment receives a status update for the step. The embodiment determines whether the status update for the step also includes a status update for a related step in the workflow, wherein the related step is also a member of the set of steps. The embodiment changes a visual indicator corresponding to the related step in accordance with the status update for the related step.

### BRIEF DESCRIPTION OF THE SEVERAL VIEWS OF THE DRAWINGS

The novel features believed characteristic of the embodiments are set forth in the appended claims. An embodiment of the invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which illustrative embodiments may be implemented;

FIG. 2 depicts a block diagram of a data processing system in which illustrative embodiments may be implemented;

FIG. 3 depicts an example client-server system for user interface for dynamic workflow state management in accordance with an illustrative embodiment;

FIG. 4 depicts a block diagram of one configuration of a dynamic state management application in accordance with an illustrative embodiment;

FIG. 5 depicts a block diagram of another configuration of a dynamic state management application in accordance with an illustrative embodiment;

FIG. 6A depicts an example user interface for user interface for dynamic workflow state management in accordance with an illustrative embodiment;

FIG. 6B depicts an example state diagram for dynamic workflow state management in accordance with an illustrative embodiment;

FIG. 7 depicts a flowchart of an example client-side process of dynamic workflow state management in accordance with an illustrative embodiment; and

FIG. 8 depicts a flowchart of an example server-side process of dynamic workflow state management in accordance with an illustrative embodiment.

### DETAILED DESCRIPTION

An enterprise application's workflow is an example of a complex workflow. For example, an enterprise application that performs a software design task may have a number of steps that have to be executed in some combination of sequential execution, parallel execution, ordered execution, or a combination thereof. Furthermore, some or all of these steps may have sub-steps that may have to execute in a similar manner.

The embodiments of the invention recognize that the actors for those steps such as users, systems, components, or a combination thereof, may perform those steps at different pace, different locations, and in combination with other tasks. Accordingly, the embodiments recognize that the progress of a step may be reported at different times and not necessarily in the order in which they were planned in the workflow.

The embodiments further recognize that the status of the workflow or a step therein depends not only on the order in which the steps or sub-steps are performed, but also on the manner of performing those steps. For example, a workflow may include twelve steps and steps one through five may have their respective status indicating that those steps have been completed. Under certain circumstances, performance of step six, even in the planned order, may cause the result of step two to become invalid.

Accordingly, the status of step two may have to be dynamically updated to an incomplete status so that step two may then be planned for repetition.

The embodiments recognize that presently available workflow management tools are largely standalone tools that manage the workflow programmed therein. Those workflow management tools that do interact over data networks only do so with other instances of the same tool to collaboratively manage a common workflow across multiple instances of the standalone tool, such as on different team-members' computers.

The embodiments recognize that presently available workflow management tools are deficient in dynamic state management of workflow steps. For example, a presently available workflow management tool may accept a progress report for a step, but does not dynamically relate the activities occurring with respect to the step to other steps that may be dependent on, consequential to, or otherwise affected by the progress of the step. Presently available workflow management tools do not dynamically evaluate status changes of other related steps from the status change of a particular step in a given workflow.

The embodiments further recognize that performing such dynamic computation for state management of the various steps of a given workflow is computationally intensive. The embodiments further recognize that dynamic state management of a workflow is also not an activity that is conducive to distribution across multiple instances of the workflow management tool.

The embodiments further recognize that presenting the workflow information, including the up-to-date information about the involved steps and sub-steps can result in a complex visual presentation of that information. Because the information volume is typically large, the interrelationships between the pieces of information are numerous, and the interdependencies of updates are complex, presently available visual methods of showing the progress of a workflow are not very user friendly or intuitive.

The illustrative embodiments used to describe the invention generally address and solve the above-described problems and other problems related to managing state information for workflows steps. The illustrative embodiments provide a method, system, and computer program product for user interface for dynamic workflow state management.

Generally, the illustrative embodiments provide a client-server model for the dynamic workflow state management. According to an embodiment, a server-based application receives the progress information relative to a step in a workflow and performs the dynamic computations for updating the status of other steps that may be affected by the progress information. The server-based application may execute on a single data processing system, or may include components that can be distributed to several data processing systems across a data network.

The server-based application generates status update information that can be distributed to one or more client applications. The one or more client applications may execute on one or more client data processing systems.

A client application presents the workflow in a visual form using a graphical user interface. Upon receiving a status update for a step and optionally for one or more related steps, the user interface on the client application is configured to display the status of the various steps in an easy to understand manner. The graphical user interface is configured to efficiently present the information pertaining to the workflow steps, status changes thereof, and relationships there-between.

The illustrative embodiments are described with respect to certain data processing systems only as examples. Such descriptions are not intended to be limiting on the illustrative embodiments. For example, an illustrative embodiment described with respect to a server data processing system can be implemented using a data processing system performing another function in a data processing environment within the scope of the illustrative embodiments.

Similarly, the illustrative embodiments are described with respect to certain data and visual renderings only as examples. Such descriptions are not intended to be limiting on the illustrative embodiments. For example, an illustrative embodiment described with respect to certain icons, graphics, or images having certain colors, shapes, sizes, or orientations can be implemented using other artifacts for a similar purpose, including but not limited to graphical, textual, audible, and tactile artifacts, and adapted for a similar purpose, within the scope of the illustrative embodiments.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the embodiments of the invention.

The illustrative embodiments are further described with respect to certain applications only as examples. Such descriptions are not intended to be limiting on the embodiments of the invention. An embodiment of the invention may be implemented with respect to any type of application, such as, for example, applications that are served, the instances of any type of server application, a platform application, a stand-alone application, an administration application, or a combination thereof.

An application, including an application implementing all or part of an embodiment, may further include data objects, code objects, encapsulated instructions, application fragments, services, and other types of resources available in a data processing environment. For example, a Java® object, an Enterprise Java Bean (EJB), a servlet, or an applet may be manifestations of an application with respect to which an embodiment of the invention may be implemented. (Java and all Java-based trademarks and logos are trademarks or registered trademarks of Oracle and/or its affiliates).

An illustrative embodiment may be implemented in hardware, software, or a combination thereof. An illustrative embodiment may further be implemented with respect to any type of data storage resource, such as a physical or virtual data storage device, that may be available in a given data processing system configuration.

The examples in this disclosure are used only for the clarity of the description and are not limiting on the illustrative embodiments. Additional data, operations, actions, tasks, activities, and manipulations will be conceivable from this disclosure and the same are contemplated within the scope of the illustrative embodiments.

The illustrative embodiments are described using specific code, designs, architectures, layouts, schematics, and tools only as examples and are not limiting on the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures.

Any advantages listed herein are only examples and are not intended to be limiting on the illustrative embodiments. Additional or different advantages may be realized by specific illustrative embodiments. Furthermore, a particular illustrative embodiment may have some, all, or none of the advantages listed above.

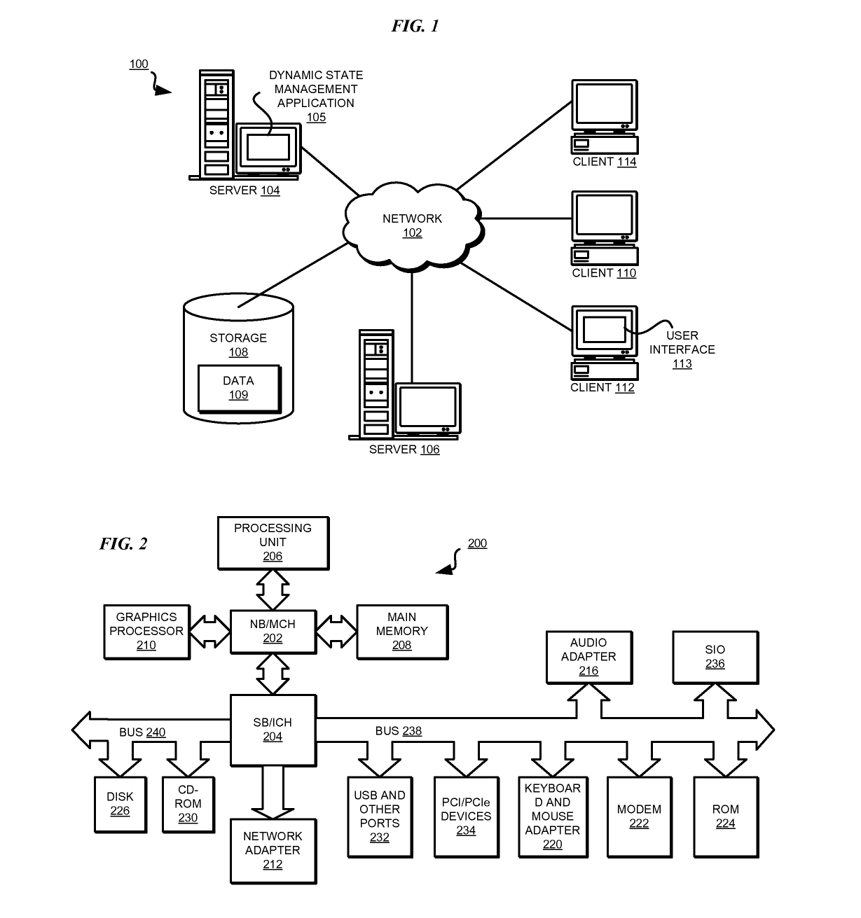

With reference to the figures and in particular with reference to FIGS. 1 and 2, these figures are example diagrams of data processing environments in which illustrative embodiments may be implemented. FIGS. 1 and 2 are only examples and are not intended to assert or imply any limitation with regard to the environments in which different embodiments may be implemented. A particular implementation may make many modifications to the depicted environments based on the following description.

FIG. 1 depicts a pictorial representation of a network of data processing systems in which illustrative embodiments may be implemented. Data processing environment 100 is a network of computers in which the illustrative embodiments may be implemented. Data processing environment 100 includes network 102. Network 102 is the medium used to provide communications links between various devices and computers connected together within data processing environment 100. Network 102 may include connections, such as wire, wireless communication links, or fiber optic cables. Server 104 and server 106 couple to network 102 along with storage unit 108. Software applications may execute on any computer in data processing environment 100.

In addition, clients 110, 112, and 114 couple to network 102. A data processing system, such as server 104 or 106, or client 110, 112, or 114 may contain data and may have software applications or software tools executing thereon.

Dynamic state management application 105 may be any suitable software application usable for performing the dynamic status change detection of related steps in the manner of an illustrative embodiment. Data 109 may be workflow information usable in dynamic state management application 105 according to an embodiment. While data 109 is depicted in storage 108, data 109 may be stored in any data processing system in data processing environment 100 within the scope of the embodiments. User interface 113 may be a graphical user interface, for example, a graphical user interface presented using a browser application, in client 112.

Servers 104 and 106, storage unit 108, and clients 110, 112, and 114 may couple to network 102 using wired connections, wireless communication protocols, or other suitable data connectivity. Clients 110, 112, and 114 may be, for example, personal computers or network computers.

In the depicted example, server 104 may provide data, such as boot files, operating system images, and applications to clients 110, 112, and 114. Clients 110, 112, and 114 may be clients to server 104 in this example. Clients 110, 112, 114, or some combination thereof, may include their own data, boot files, operating system images, and applications. Data processing environment 100 may include additional servers, clients, and other devices that are not shown.

In the depicted example, data processing environment 100 may be the Internet. Network 102 may represent a collection of networks and gateways that use the Transmission Control Protocol/Internet Protocol (TCP/IP) and other protocols to communicate with one another. At the heart of the Internet is a backbone of data communication links between major nodes or host computers, including thousands of commercial, governmental, educational, and other computer systems that route data and messages. Of course, data processing environment 100 also may be implemented as a number of different types of networks, such as for example, an intranet, a local area network (LAN), or a wide area network (WAN). FIG. 1 is intended as an example, and not as an architectural limitation for the different illustrative embodiments.

Among other uses, data processing environment 100 may be used for implementing a client-server environment in which the illustrative embodiments may be implemented. A client-server environment enables software applications and data to be distributed across a network such that an application functions by using the interactivity between a client data processing system and a server data processing system. Data processing environment 100 may also employ a service oriented architecture where interoperable software components distributed across a network may be packaged together as coherent business applications.

With reference to FIG. 2, this figure depicts a block diagram of a data processing system in which illustrative embodiments may be implemented. Data processing system 200 is an example of a computer, such as server 104 or client 110 in FIG. 1, in which computer usable program code or instructions implementing the processes of the illustrative embodiments may be located for the illustrative embodiments.

In the depicted example, data processing system 200 employs a hub architecture including North Bridge and memory controller hub (NB/MCH) 202 and south bridge and input/output (I/O) controller hub (SB/ICH) 204. Processing unit 206, main memory 208, and graphics processor 210 are coupled to north bridge and memory controller hub (NB/MCH) 202. Processing unit 206 may contain one or more processors and may be implemented using one or more heterogeneous processor systems. Graphics processor 210 may be coupled to the NB/MCH through an accelerated graphics port (AGP) in certain implementations.

In the depicted example, local area network (LAN) adapter 212 is coupled to south bridge and I/O controller hub (SB/ICH) 204. Audio adapter 216, keyboard and mouse adapter 220, modem 222, read only memory (ROM) 224, universal serial bus (USB) and other ports 232, and PCI/PCIe devices 234 are coupled to south bridge and I/O controller hub 204 through bus 238. Hard disk drive (HDD) 226 and CD-ROM 230 are coupled to south bridge and I/O controller hub 204 through bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM 230 may use, for example, an integrated drive electronics (IDE) or serial advanced technology attachment (SATA) interface. A super I/O (SIO) device 236 may be coupled to south bridge and I/O controller hub (SB/ICH) 204.

An operating system runs on processing unit 206. The operating system coordinates and provides control of various components within data processing system 200 in FIG. 2. The operating system may be a commercially available operating system such as Microsoft® Windows® (Microsoft and Windows are trademarks of Microsoft Corporation in the United States, other countries, or both), or Linux® (Linux is a trademark of Linus Torvalds in the United States, other countries, or both). An object oriented programming system, such as the Java™ programming system, may run in conjunction with the operating system and provides calls to the operating system from Java™ programs or applications executing on data processing system 200 (Java and all Java-based trademarks and logos are trademarks or registered trademarks of Oracle and/or its affiliates).

Program instructions for the operating system, the object-oriented programming system, the processes of the illustrative embodiments, and applications or programs are located on storage devices, such as hard disk drive 226, and may be loaded into a memory, such as, for example, main memory 208, read only memory 224, or one or more peripheral devices, for execution by processing unit 206. Program instructions may also be stored permanently in non-volatile memory and either loaded from there or executed in place. For example, the synthesized program according to an embodiment can be stored in non-volatile memory and loaded from there into DRAM.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. In addition, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may comprise one or more buses, such as a system bus, an I/O bus, and a PCI bus. Of course, the bus system may be implemented using any type of communications fabric or architecture that provides for a transfer of data between different components or devices attached to the fabric or architecture.

A communications unit may include one or more devices used to transmit and receive data, such as a modem or a network adapter. A memory may be, for example, main memory 208 or a cache, such as the cache found in north bridge and memory controller hub 202. A processing unit may include one or more processors or CPUs.

The depicted examples in FIGS. 1-2 and above-described examples are not meant to imply architectural limitations. For example, data processing system 200 also may be a tablet computer, laptop computer, or telephone device in addition to taking the form of a PDA.

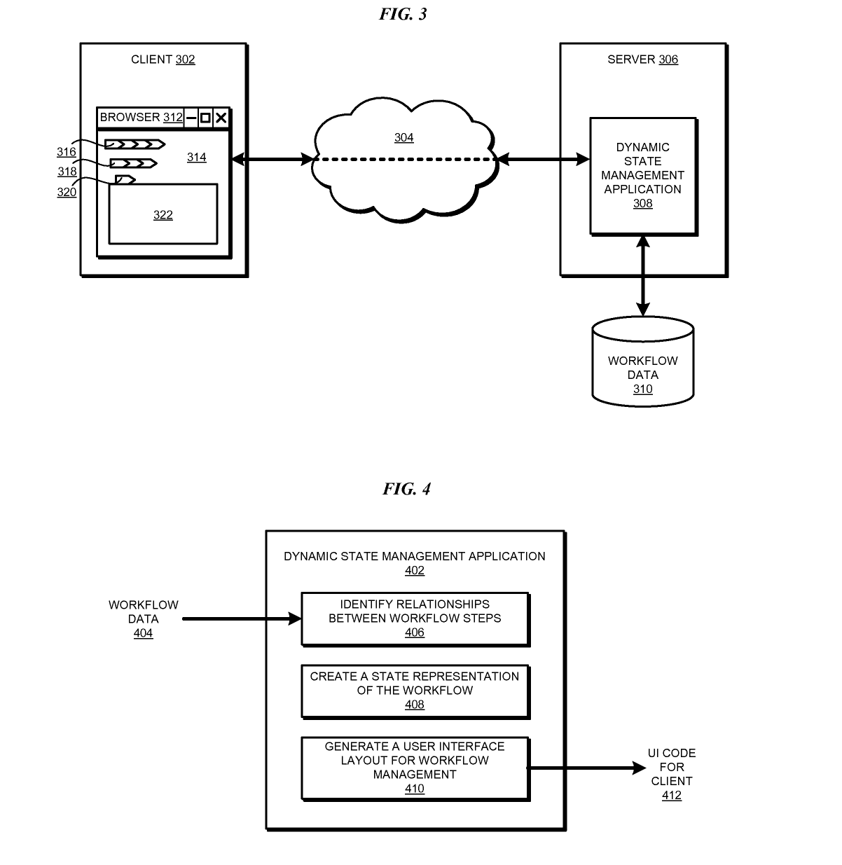

With reference to FIG. 3, this figure depicts an example client-server system for user interface for dynamic workflow state management in accordance with an illustrative embodiment. Client 302 may be analogous to client 112 in FIG. 1, network 304 may be analogous to network 102 in FIG. 1, and server 306 may be analogous to server 104 in FIG. 1. Dynamic state management application 308 may similar to dynamic state management application 105 in FIG. 1. Workflow data 310 may be similar to data 109 in FIG. 1.

Dynamic state management application 308 uses workflow data 310 to identify the steps of the workflow. For example, using workflow data 310, dynamic state management application 308 may generate a state diagram representation for the given workflow, where a state may represent a step or a sub-step of the workflow. State transitions in such a state diagram may represent conditions for a state's (step's or sub-step's) complete or incomplete status.

Generally, browser 312 may be any application suitable for displaying graphical information. Preferably, browser 312 may be an internet browser application. Browser 312 is depicted to graphically display user interface (UI) 314. According to an embodiment, UI 314 displays a set of steps of a workflow as set of tabs 316. Sub-steps of a step appear as a set of tabs 318. Any sub-steps of a sub-step appear as set of tabs 320. A hierarchy of steps and sub-steps can be displayed in a similar manner using sets of tabs regardless of the number of levels in the hierarchy.

Display 322 displays the information pertaining to a step (or sub-step). Display 322 can be presented for any step or sub-step regardless of whether that step or sub-step has further sub-steps. UI 314 interacts with dynamic state management application 308, such as by using the functions provided by browser 312 for such interactions, to receive status updates for sets of tabs 316, 318, or 320.

Typical applications used for presenting information visually, such as an Internet Browser, have limited screen space. A graphical user interface according to an embodiment, organized as multi level, multi-row tabs, provides intuitive node graph hierarchy view of the workflow. One advantage of a tab based view according to an embodiment is that a user can view the entire workflow in a single view. A tabs based view according to an embodiment can of-course be supplemented by, or be complementary to, a graph based view of the workflow.

Furthermore, in an embodiment, the tabs (nodes of the workflow) may further include a tooltip to indicate the pre-requisites/dependencies for the tab, so that the user knows that the pre-requisites/dependencies have to be satisfied before the tab becomes usable. As an example, a workflow may be represented as a node graph, which contains the following nodes—a current node (currently active node), a parent node (the parent of the current node), a sibling node (a node at the same level as the current node and having the same parent node), a child node (or children nodes, of the current node), and other nodes (all remaining nodes, e.g. children of the sibling nodes).

Furthermore, according to an embodiment, a node can have one of the following states—eligible (the node step can be executed as all the pre-requisites/dependencies have been satisfied), not eligible (the node step cannot be completed as some pre-requisites have not been completed yet), done (the node step successfully completed), partially done (the node action has partially completed), or re-execute (the node step should be re-executed due to steps/sub-steps that were completed in another node).

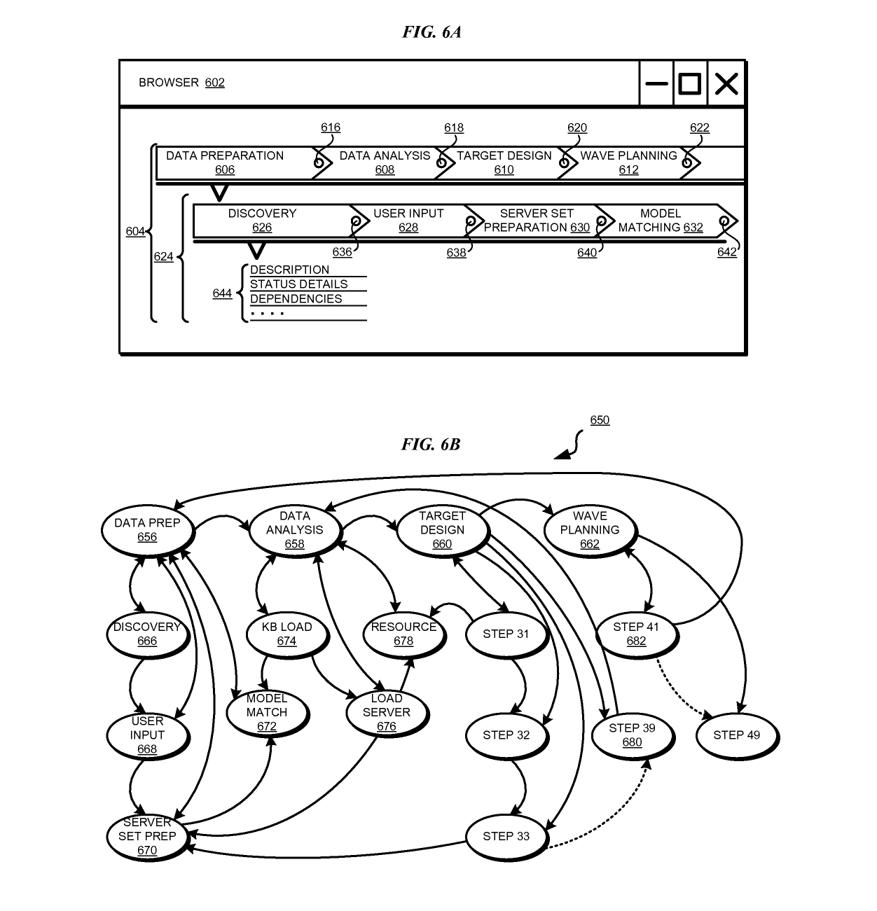

Additionally, the state of a step, as represented by a tab, may be represented using suitable visual cues. For example, traffic light type color coding—red, green, and yellow—or checks, crosses, or dashes, may quickly inform a user of the status of a step associated with a tab. The indication of status and status changes using UI 314 is described in more detail, as in another embodiment, with respect to FIG. 6.

With reference to FIG. 4, this figure depicts a block diagram of one configuration of a dynamic state management application in accordance with an illustrative embodiment. Dynamic state management application 402 may be analogous to dynamic state management application 308 in FIG. 3. Workflow data 404 may be similar to workflow data 310 in FIG. 3.

Dynamic state management application 402 receives workflow data 404. Dynamic state management application 402 includes component 406 to identify relationships between workflow steps. Component 406, or another component in dynamic state management application (not shown), may be further configured to identify steps in given workflow data 404 from which component 406 identifies the relationships. Some examples of the relationships may be dependency of one step on another, sequencing order of certain steps, consequential relationship of one step's status with another step, or causal relationship between a manner of performing a step and another a status of step. Furthermore, the relationships may also include different relationships between two steps depending on different status, progress, or manner of accomplishing the step.

These examples of the various relationships possible between steps (or sub-steps) in a workflow are not intended to be limiting on the illustrative embodiments. Many other types of relationships will be conceivable from this disclosure to those of ordinary skill in the art.

Component 408 in dynamic state management application 402 creates a state representation of the workflow in the manner described above. In one embodiment, component 408 may create another suitable representation for the steps, sub-steps, and the relationships there-between.

Component 410 generates a user interface layout for managing the given workflow. Component 410 may output the UI code for use at a client, such as in browser 312 in client 302 in FIG. 3.

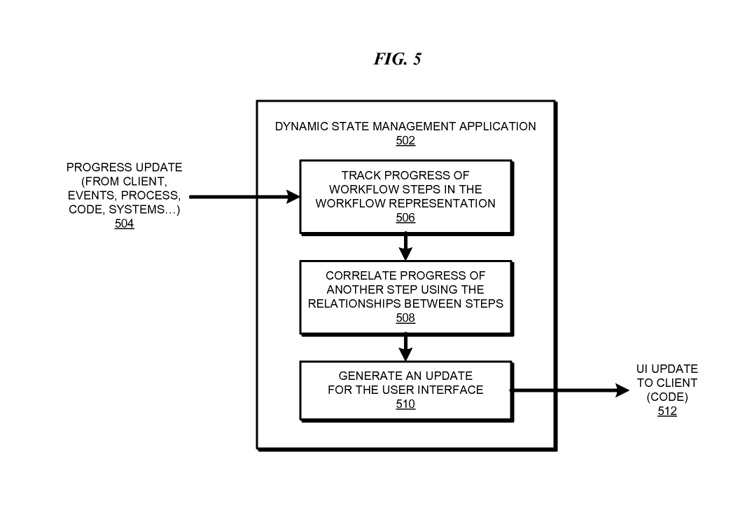

With reference to FIG. 5, this figure depicts a block diagram of another configuration of a dynamic state management application in accordance with an illustrative embodiment. Dynamic state management application 502 may be analogous to dynamic state management application 402 in FIG. 4.

Dynamic state management application 502 receives progress update 504 for a workflow step. Progress update 504 may be generated, for example, by a user, a client application, events in a data processing environment, another process or workflow, code executing in a data processing system, or a system performing the step.

Component 506 in dynamic state management application 502 tracks the progress of workflow steps in a representation of the workflow. For example, component 506 may track the progress using a state diagram representation of the workflow as described in an example earlier.

Component 508 correlates the progress of a workflow step with other steps using the relationships between the steps of the workflow. Component 510 generates an update for the UI by generating UI update code 512 for a client application that displayed the UI using UI code 412 in FIG. 4. A UI on a client data processing system may use the UI update code as explained using an example illustration in FIG. 6A.

With respect to FIG. 6A, this figure depicts an example user interface for user interface for dynamic workflow state management in accordance with an illustrative embodiment. Browser 602 may be analogous to browser 312 in FIG. 3. UI 604 may be analogous to UI 314 in FIG. 3.

UI 604 is depicted in this figure as including certain steps of a workflow only as an example, without implying any limitation on the types of steps or workflows that can benefit from an embodiment. As an example, a workflow may include, among other steps, example step 606 for data preparation, example step 608 for data analysis, example step 610 for target design, and example step 612 for wave planning.

A step is represented as a tab graphic in UI 604 in this example, steps 606-612 being represented as a set of tabs as shown. Further as an example, visual indicator 616 on the tab corresponding to step 606 visually indicates a status of step 606 at a given time. Similarly, visual indicator 618 on the tab corresponding to step 608 visually indicates a status of step 608 at a given time, visual indicator 620 on the tab corresponding to step 610 visually indicates a status of step 610 at a given time, and visual indicator 622 on the tab corresponding to step 612 visually indicates a status of step 612 at a given time.

In one embodiment, indicators 616, 618, 620, and 622 may visually indicate the status of the corresponding tabs and steps by changing to a certain color. For example, indicator 616 in green color would indicate that step 606 is complete, to wit, the status of step 606 is set to “complete.” Likewise, indicator 616 in red color would indicate that step 606 is incomplete (or not started), and indicator 616 in yellow color would indicate that step 606 is partially complete.

A user may gain further information about step 606 by manipulating the corresponding tab graphic. For example, clicking, using a mouse pointer, the tab graphic associated with step 606 may expand the tab of step 606 into area 624. Area 624 of UI 604 may display another set of tabs, each of which corresponds to a sub-step of step 606.

For example, data preparation step 606 of the depicted workflow may include sub-step 626 for discovery, sub-step 628 for user input, sub-step 630 for server set preparation, and sub-step 632 for model matching. As in the previous example, visual indicator 636 on the tab corresponding to step 626 visually indicates a status of step 626 at a given time. Similarly, visual indicator 638 on the tab corresponding to step 628 visually indicates a status of step 628 at a given time, visual indicator 640 on the tab corresponding to step 630 visually indicates a status of step 630 at a given time, and visual indicator 642 on the tab corresponding to step 632 visually indicates a status of step 632 at a given time.

In one embodiment, indicators 636, 638, 640, and 642 may visually indicate the status of the corresponding tabs and sub-steps by changing to a certain color in the manner of indicators 616-622. Note that colors of visual indicators 616-622 and 636-642 are only used as an example way of visually indicating a status of the corresponding tabs and steps. One of ordinary skill in the art would be able to conceive many other variations of visual indications that may be similarly used on UI 604 to indicate the status of the various steps on the corresponding tabs, and the same are contemplated within the scope of the illustrative embodiments.

For any step, such as for step 626 as depicted in this figure, description 644 may be presented on UI 604. Description 644 may be textual, graphical, tactile, or a combination form of communicating to a user the information pertaining to a step of the workflow. As in the depicted example, description 644 pertains to step 626, and may present, including but not limited to, a description of step 626, details of the status of step 626, dependencies of step 626, and dependencies of other steps on step 626.

As an example operation, step 606 may have been previously completed and may be indicated by green coloration of visual indicator 616. Completion of step 628 may cause visual indicator 638 to become green but visual indicator 616 to become yellow. Such a related status change is possible using an embodiment by identifying a relationship between sub-step 628 and step 606.

For example, when sub-steps 626-632 have been completed and data preparation step 606 is deemed complete (indicated by green visual indicator 616), new user input may be received. Having received new user input, sub-step 628 may be deemed completed (for the first time or again after previously having been completed). Having received new user input for sub-step 628, however, data preparation step 606 may have to be re-evaluated with respect to the new user input, and therefore step 606 reverts to an incomplete or partially complete status (as indicated by a red or yellow color of visual indicator 616).

Note that the a state of the given workflow, status of a given step within the given workflow, can be implemented using visual indicators of any type without implying a limitation of specific colors, or colors in general, on the embodiments. For example, visual indicators 616, 681, 620, 622, 636, 638, 640, and 642 may be a combination of color-coded graphical icons, icons of varying shapes, sizes, or a combination thereof.

Furthermore, (not shown in the figure), a tooltip may be presented in conjunction with a tab, to inform a user about the actions possible with the tab, reasons why the tab is depicted in a particular manner, or to communicate additional information about the tab, the step represented by the tab, or the workflow as relates to the tab. An example of a tooltip is described earlier with respect to FIG. 3.

The relationship for the above example—that new user input after data preparation is completed requires new data preparation—is identified using dynamic state management application management application configurations 402 in FIGS. 4 and 502 in FIG. 5 as described earlier.

FIG. 6B depicts an example state diagram for dynamic workflow state management in accordance with an illustrative embodiment. State diagram 650 may be a representation of information managed and computed on the server-side, such as in dynamic state management application management application 402 in FIG. 4. Each state in state diagram 650 is a node.

Node 656 represents the data preparation step of the example workflow of FIG. 6A, as represented by tab 606 in FIG. 6A. Similarly, node 658 represents the data analysis step as represented by tab 608 in FIG. 6A, node 660 represents the target design step as represented by tab 610 in FIG. 6A, and node 662 represents the wave planning step as represented by tab 612 in FIG. 6A. Node 666 represents the discovery sub-step as represented by tab 626 in FIG. 6A, node 668 represents the user input sub-step as represented by tab 628 in FIG. 6A, node 670 represents the server set preparation sub-step as represented by tab 630 in FIG. 6A, and node 672 represents the model matching sub-step as represented by tab 632 in FIG. 6A.

Nodes 674, 676, and 678 represent example sub-steps of the data analysis step represented by node 658.

As an example, node 656 may be in state “eligible” at the beginning of the workflow and states 658-662 may be in state “not eligible”. During the performance of the data preparation step of node 656, such as when the discovery step of node 666 is completed and indicated by state “done” and the user input step is “partially done”, the state of data preparation step of node 656 may also change to “partially done”.

Notice, for example, that the model matching step of node 672 is reached as a result of performing a sub-step of the data preparation step (from node 670) as well as from performing a sub-step of the data analysis step (from node 674). Suppose that model matching sub-step was completed and indicated as “done” while performing the data preparation step of node 656, resulting in node 656 having the state “done”. Now suppose that model matching sub-step is re-executed as a part of data analysis step of node 658. The re-execution of node 672 (the model matching sub-step) may cause some change in data relating to the workflow.

Assume that it would be desirable to consider the changed data in the data preparation step of node 656. According to an embodiment, the change in the state of node 672 as a result of performing node 658 may change the state of node 656 from “done” to “re-execute”. Such a change in the state of node 656 may cause nodes 666, 668, 670, and 672 to be performed again, considering the changed data from the previous execution of node 672.

Many other examples of such state management actions according to an embodiment are evident in the example depiction of FIG. 6B. For example, executing step 39 of node 680 may be a part of executing the target design step of node 660. Executing node 680, however, may cause some data change in the workflow that may change the state of node 656, of example, from “done” to “partially done” or “re-execute”.

As another example, executing step 41 of node 682 may be a part of executing the wave planning step of node 662. Executing node 682, however, may cause some data change in the workflow that may change the state of node 658, of example, from “done” to “partially done” or “re-execute”.

According to an embodiment, not only are the nodes of state diagram 650 represented in FIG. 6A, but the states, as they change with the progress of the workflow, are also reported on the UI of FIG. 6A, such as via tool-tips of visual indicators on the tabs, or other similar visual artifacts of a graphical UI.

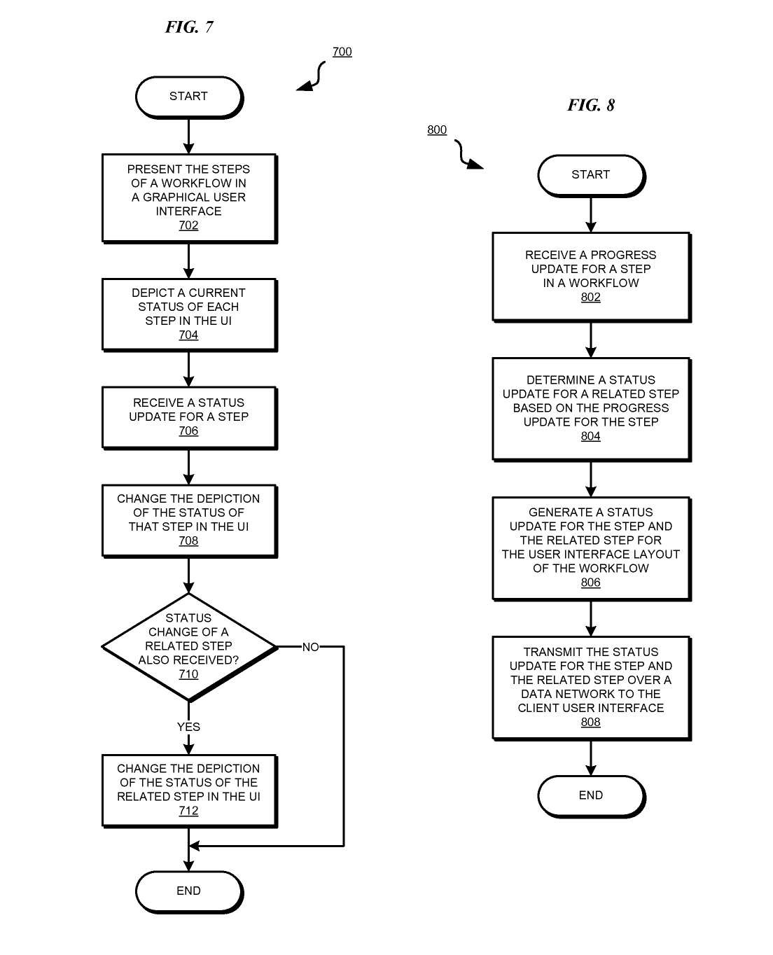

With reference to FIG. 7, this figure depicts a flowchart of an example client-side process of dynamic workflow state management in accordance with an illustrative embodiment. Process 700 may be implemented in a client-side UI, such as UI 604 in FIG. 6.

Process 700 begins by presenting the steps of a given workflow in a graphical user interface (step 702). Process 700 depicts a current status of each step in the UI (step 704).

Process 700 receives a status update for a step (step 706). Process 700 changes the depiction of the status of that step in the UI (step 708). Process 700 determines whether a status change for a related step is also received (step 710). If a status change for a related step is also received (“Yes” path of step 710), process 700 changes the depiction of the status of the related step in the UI as well (step 712). Process 700 ends thereafter. If a status change for a related step is not received (“No” path of step 710), process 700 ends thereafter as well.

With reference to FIG. 8, this figure depicts a flowchart of an example server-side process of dynamic workflow state management in accordance with an illustrative embodiment. Process 800 may be implemented in a dynamic state management application, such as in a combination of the configurations of dynamic state management application 402 in FIG. 4 and dynamic state management application 502 in FIG. 5.

Process 800 begins by receiving a progress update for a workflow step (step 802). Process 800 determines a status update for a related step based on the progress update for the step (step 804). Process 800 generates a status update for the workflow step and the related step for the UI layout of the workflow (step 806). Process 800 transmits the generated status updates over a data network to a client-side UI (step 808). Process 800 ends thereafter.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Thus, a computer implemented method, system, and computer program product are provided in the illustrative embodiments for user interface for dynamic workflow state management. Using an embodiment of the invention, information pertaining to the steps and sub-steps that form the workflow are presented graphically and updated using server-side logic for status updates. The graphical UI of an embodiment may be more intuitive, use a browser page more efficiently, and be more user friendly as compared to presently available workflow management tools. An embodiment uses more intuitive progress indicators, which, in response to progress in one or more of the workflow steps, are automatically updated for other steps in the workflow that may be affected by the progress in those one or more steps.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable storage device(s) or computer readable media having computer readable program code embodied thereon.

Any combination of one or more computer readable storage device(s) or computer readable media may be utilized. The computer readable medium may be a computer readable signal medium or a computer readable storage medium. A computer readable storage device may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage device would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage device may be any tangible device or medium that can contain, or store a program for use by or in connection with an instruction execution system, apparatus, or device.

Program code embodied on a computer readable storage device or computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to one or more processors of one or more general purpose computers, special purpose computers, or other programmable data processing apparatuses to produce a machine, such that the instructions, which execute via the one or more processors of the computers or other programmable data processing apparatuses, create means for implementing the functions/acts specified in the flowchart and/or block diagram block or blocks.

These computer program instructions may also be stored in one or more computer readable storage devices or computer readable that can direct one or more computers, one or more other programmable data processing apparatuses, or one or more other devices to function in a particular manner, such that the instructions stored in the one or more computer readable storage devices or computer readable medium produce an article of manufacture including instructions which implement the function/act specified in the flowchart and/or block diagram block or blocks.

The computer program instructions may also be loaded onto one or more computers, one or more other programmable data processing apparatuses, or one or more other devices to cause a series of operational steps to be performed on the one or more computers, one or more other programmable data processing apparatuses, or one or more other devices to produce a computer implemented process such that the instructions which execute on the one or more computers, one or more other programmable data processing apparatuses, or one or more other devices provide processes for implementing the functions/acts specified in the flowchart and/or block diagram block or blocks.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

What is claimed is:

1. A computer implemented method for a user interface for dynamic workflow state management, the method comprising:
presenting a set of steps of a workflow as a set of tabs in a graphical user interface (UI) displayed using an application executing in a first data processing system, each tab in the set of tabs including a visual indicator configured to indicate a current status of a corresponding step in the set of steps associated with that tab;
depicting, for a step in the set of steps, using a visual indicator in a tab in the set of tabs, in the graphical UI, a current status of the step in the workflow, the visual indicator being configured to visually change with a change in the status of the step;
receiving a status update for the step;
determining whether the status update for the step also includes a status update for a related step in the workflow, wherein the related step is also a member of the set of steps;
changing a visual indicator corresponding to the related step in accordance with the status update for the related step.

2. The computer implemented method of claim 1, further comprising:
identifying a relationship between the step and the related step in the workflow;
receiving a progress information for the step;
generating the status update for the step;
determining whether a status of the related step is to be changed due to the status update for the step; and
generating a status update for the related step responsive to determining that the status of the related step is to be changed due to the status update for the step.

3. The computer implemented method of claim 2, wherein the identifying the relationship, the receiving the progress information, the generating the status update for the step, the determining whether the status of the related step is to be changed, and the generating the status update for the related step occur over a data network and in communication with a dynamic state management application executing on a second data processing system.

4. The computer implemented method of claim 3, further comprising:
transmitting the status update for the step, the transmitting including the status update for the related step, the transmitting occurring from the dynamic state management application executing on the second data processing system to the application executing in a first data processing system.

5. The computer implemented method of claim 1, wherein the set of tabs further includes a subset of tabs, each tab in the subset corresponding to a sub-step of a step in the set of steps of the workflow, and wherein the step is not a sub-step of the related step.

6. The computer implemented method of claim 1, wherein the first application is an Internet browser application.

7. A computer implemented method for user interface for dynamic workflow state management, the method comprising:
receiving, at a dynamic state management application executing on a first data processing system, a progress update for a step in a workflow;
determining a status update for a related step in the workflow based on the progress update for the step;
generating first code for visually depicting, on a user interface, a first status change corresponding to the progress update for the step;
generating second code for visually depicting, on the user interface, a second status change corresponding to the status update for the related step; and
transmitting the first code and the second code to a second application executing on a second data processing system such that the first code causes a visual change in a first visual indicator associated with the step and the second code causes a visual change in a second visual indicator associated with the related step, the first and the second visual indicators being presented by the second application on the second data processing system.

8. The computer implemented method of claim 7, wherein the progress update is provided by a third application executing on a third data processing system.

9. The computer implemented method of claim 7, wherein the user interface is a graphical user interface in the second application, further comprising:
presenting a set of steps of the workflow as a set of tabs in the graphical user interface in the second application, each tab in the set of tabs including a visual indicator configured to indicate a current status of a step associated with that tab, and wherein the step and the related step are members of the set of steps.

10. The computer implemented method of claim 9, wherein the set of tabs further includes a subset of tabs, each tab in the subset corresponding to a sub-step of a step in the set of steps of the workflow, and wherein the step is not a sub-step of the related step.

11. The computer implemented method of claim 7, wherein the first data processing system is a server data processing system, the second application is an Internet browser application, and the second data processing system is a client data processing system.

12. A computer usable program product comprising a computer usable storage medium including computer usable code for a user interface for dynamic workflow state management, the computer usable code comprising:
computer usable code for presenting a set of steps of a workflow as a set of tabs in a graphical user interface (UI) displayed using an application executing in a first data processing system, each tab in the set of tabs including a visual indicator configured to indicate a current status of a corresponding step in the set of steps associated with that tab;
computer usable code for depicting, for a step in the set of steps, using a visual indicator in a tab in the set of tabs, in the graphical UI, a current status of the step in the workflow, the visual indicator being configured to visually change with a change in the status of the step;
computer usable code for receiving a status update for the step;
computer usable code for determining whether the status update for the step also includes a status update for a related step in the workflow, wherein the related step is also a member of the set of steps;
computer usable code for changing a visual indicator corresponding to the related step in accordance with the status update for the related step.

13. The computer usable program product of claim 12, further comprising:
computer usable code for identifying a relationship between the step and the related step in the workflow;
computer usable code for receiving a progress information for the step;
computer usable code for generating the status update for the step;
computer usable code for determining whether a status of the related step is to be changed due to the status update for the step; and
computer usable code for generating a status update for the related step responsive to determining that the status of the related step is to be changed due to the status update for the step.

14. The computer usable program product of claim 13, wherein the identifying the relationship, the receiving the progress information, the generating the status update for the step, the determining whether the status of the related step is to be changed, and the generating the status update for the related step occur over a data network and in communication with a dynamic state management application executing on a second data processing system.

15. The computer usable program product of claim 14, further comprising:
computer usable code for transmitting the status update for the step, the transmitting including the status update for the related step, the transmitting occurring from the dynamic state management application executing on the second data processing system to the application executing in a first data processing system.

16. The computer usable program product of claim 12, wherein the set of tabs further includes a subset of tabs, each tab in the subset corresponding to a sub-step of a step in the set of steps of the workflow, and wherein the step is not a sub-step of the related step.

17. The computer usable program product of claim 12, wherein the first application is an Internet browser application.

18. The computer usable program product of claim 12, wherein the computer usable code is stored in a computer readable storage medium in a data processing system, and wherein the computer usable code is transferred over a network from a remote data processing system.

19. The computer usable program product of claim 12, wherein the computer usable code is stored in a computer readable storage medium in a server data processing system, and wherein the computer usable code is downloaded over a network to a remote data processing system for use in a computer readable storage medium associated with the remote data processing system.
